(19) United States
(12) Patent Application Publication
(10) Pub. No.: US 2003/0236799 A1
(43) Pub. Date: Dec. 25, 2003

(54) Method for managing files and dependent applications that act on them

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/177,409

(22) Filed: Jun. 20, 2002

(51) Int. Cl. G06F 17/30

(52) U.S. Cl. 707/203

(57) ABSTRACT

A method, program and system for downloading and deleting applications associated with particular file types are provided. The invention comprises, when opening a browser, determining if a given file type has an associated application on the computer. If the file type does not have an associated application, the invention determines if the user has previously been asked about this file type. If the user has not previously been asked about this file type, the invention asks if the user wants to download the associated application for the file type. If user chooses to, the application is downloaded. When a user enters a request to delete a program from the computer, the invention determining if the program is the last one servicing a given file type on the computer. If the program is not the last one servicing this file type, this program is deleted. If the program is the last one servicing that file type, the invention searches the computer to determine if there are any files using that type. If there are, the invention give the user the opportunity to delete such file.

### BACKGROUND OF THE INVENTION

1. Technical Field

The present invention relates generally to computer applications, and more specifically to installing and deleting applications associated with particular file types.

2. Description of Related Art

Computer files often require specific applications in order for users to properly access them. Many of these applications are preloaded onto the computer whether or not the user has specific files which require those applications.

However, a user may also install an application on a computer specifically to handle a particular file. This occurs often when downloading files from a network. For example, if a user downloads a file from the Internet, the user's machine may not have the necessary application for using the file. Therefore, the user must download the application in addition to the file.

In many cases, the user may only require an application for one particular file, or a small group of files. Downloading applications for use with specific files can create storage problems on the computer, requiring some of these applications to be deleted.

In general, there are problems with deleting applications when the system still contains files that require those applications. As explained above, such applications are usually downloaded because files that require these applications were downloaded first.

Therefore it would be desirable to have method fro determining which applications need to be downloaded for use with particular types of files, as well as a method for determining whether such applications are no longer needed and may be deleted.

### SUMMARY OF THE INVENTION

The present invention provides a method, program and system for downloading and deleting applications associated with particular file types. The invention comprises, when opening a browser, determining if a given file type has an associated application on the computer. If the file type does not have an associated application, the invention determines if the user has previously been asked about this file type. If the user has not previously been asked about this file type, the invention asks if the user wants to download the associated application for the file type. If user chooses to, the application is downloaded.

When a user enters a request to delete a program from the computer, the invention determining if the program is the last one servicing a given file type on the computer. If the program is not the last one servicing this file type, this program is deleted. If the program is the last one servicing that file type, the invention searches the computer to determine if there are any files using that type. If there are, the invention give the user the opportunity to delete such file.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a flowchart illustrating a process for downloading necessary applications during web browser start in accordance with the present invention;

FIG. 5 depicts a flowchart illustrating an application deletion process in accordance with the present invention; and

FIG. 6 depicts a flowchart illustrating an alternate application deletion process in accordance with the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

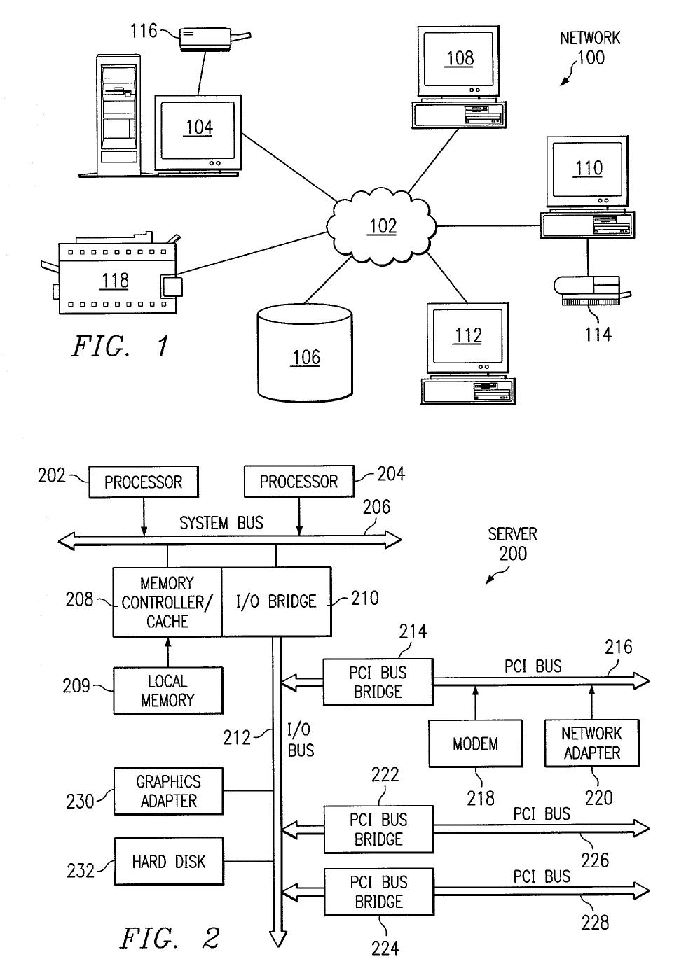

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly. Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

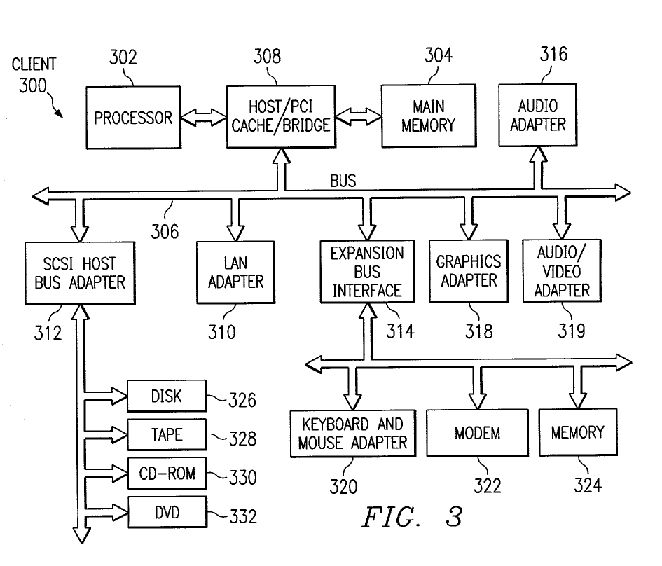

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, CD-ROM drive 330, and DVD drive 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method for ensuring that any files downloaded to computers have the necessary application(s) for proper access.

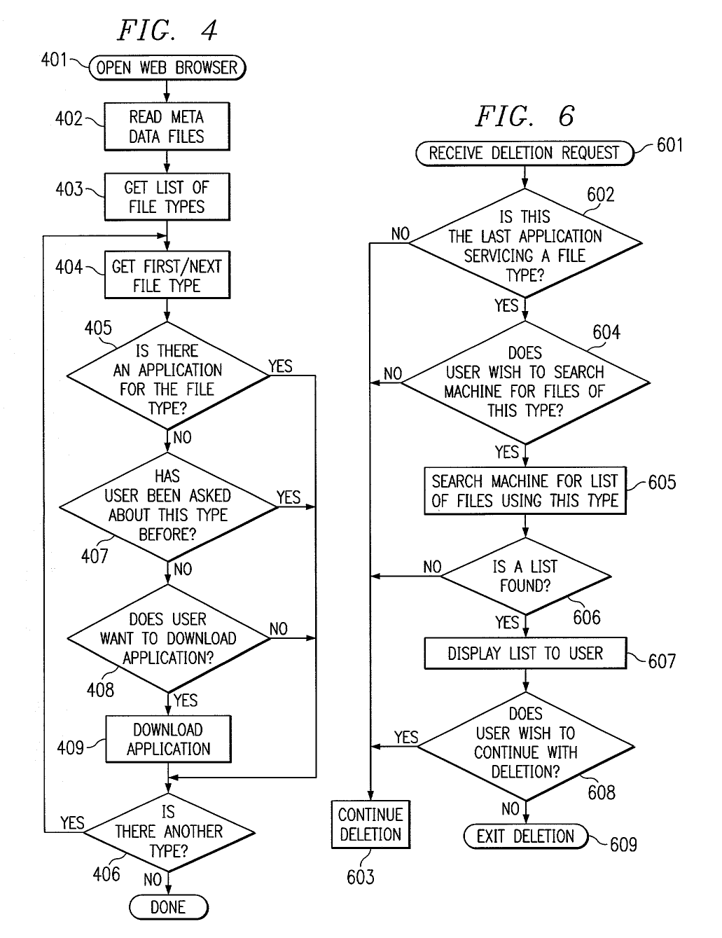

Referring to FIG. 4, a flowchart illustrating a process for downloading necessary applications during web browser start is depicted in accordance with the present invention. When the web browser is opened (step 401), it reads the meta data files, which include book marks, caches and history (step 402), and gets a list of file types (step 403).

The browser then retrieves the first file type in the list (step 404), and determines if the machine contains an application for using that file type (step 405). If the machine does have such an application, the browser checks the list for more file types (step 406). If there are more file types in the list, the browser retrieves the next one (step 404). If there are no more file types in the list, the browser is done.

If the machine does not have an application needed to use the file type in question, the browser determines if the user has already been asked about this file type before (step 407). To facilitate this inquiry, the browser maintains a record of what types of files and associated applications the user has rejected in the past and ignore those file types in the future. If the user has previously been asked about this file type, the browser moves on to check the list for more file types, as explained above (step 406).

If the user has not yet been asked about the file type in question, the browser asks if the user wants to download the necessary application for that file type (step 408). If the user does not want to download the application for the file type in question, the browser records this and returns to step 406 to check for more file types in the list. If the user does want the application, the browser downloads the application to the machine (step 409).

After the browser downloads the application, it returns to step 406 to check for remaining file types in the list. If there are no more file types to check, the process is complete.

In order to manage storage space on a computer, applications may have to be deleted. Ideally, the user should delete applications that are no longer in regular use. Examples of such applications include applications that are downloaded for use with specific files. Once the files are no longer used, the applications needed for those files can be discarded. However, when deleting applications, users may often forget about certain files for which they still have use, and which rely on the application(s) to be deleted. Therefore, when deleting applications, it is important to determine if any files remain that depend on that application, and whether the user wants to keep such files.

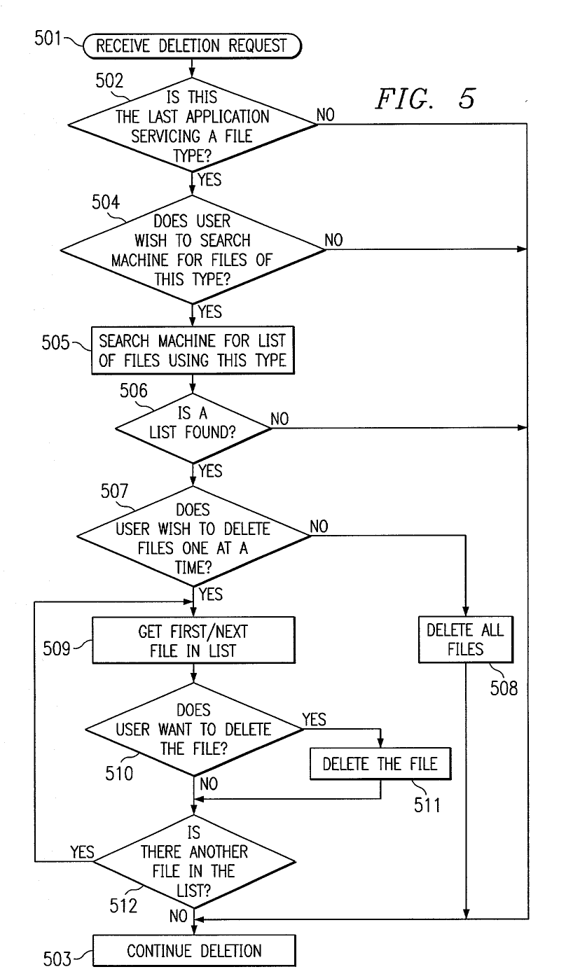

Referring to FIG. 5, a flowchart illustrating an application deletion process is depicted in accordance with the present invention. When the user enters a deletion request for an application (step 501), the deletion program first determines if the application in question is the last servicing a particular type of file (step 502). If the application is not the last one servicing the file type, then the deletion process continues (step 503).

If the application is the last one servicing the file type, the deletion program asks the user whether or not the user wishes to search the machine for files of this particular type (step 504). If the user does not want to search the machine, then the deletion continues (step 503).

If the user does want to search the machine for the file type, the deletion program searches the machine for a list of files using this type (step 505). If a list of such files is not found, the deletion process continues (step 503).

If a list of files using the type in question is found on the machine, the deletion program asks the user if the user wants to delete all of the files at once, or one at a time (step 507). If the user chooses to delete the falls all at once, the deletion program does so (step 508) and then continues with the deletion process (step 503).

If the user prefers to delete the files in the list one at a time, the deletion program gets the first file in the list (step 509), and asks if the user wants to delete the file (step 510). If the user chooses not to delete the file, the deletion program determines if there is another file in the list (step 512). If the user does choose to delete the file, the deletion program does so (step 511), and then check for other files in the list (step 512).

If there are other files in the list, the deletion program gets the next file from the list (step 509). If there are no more files in the list, the deletion process continues (step 503).

Referring to FIG. 6, a flowchart illustrating an alternate application deletion process is depicted in accordance with the present invention. When the user enters a deletion request for an application (step 601), the deletion first determines if the application in question is the last servicing a particular type of file (step 602). If the application is not the last one servicing the file type, then the deletion process continues (step 603).

If the application is the last one servicing the file type, the deletion program asks the user whether or not the user wishes to search the machine for files of this particular type (step 604). If the user does not want to search the machine, then the deletion process continues (step 603).

If the user does want to search the machine for the file type, the deletion program searches the machine for a list of files using this type (step 605). If a list of such files is not found, the deletion process continues (step 603).

If a list of files using the type in question is found on the machine, the deletion program displays the list to the user (step 607), and asks if the user wishes to continue with the deletion of the application (step 608). If the user wishes to continue, the application is deleted (step 603). If the user chooses not to continue the deletion, the deletion program exits (step 609).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for downloading applications to a computer for use with particular file types, the method comprising the computer implemented steps of:
opening a browser program in response to a request from a user;
determining if a given file type has an associated application on the computer;
if said file type does not have said associated application on the computer, determining if said user has previously been asked about said file type;
if said user has not previously been asked about said file type, asking if said user wants to download said associated application for said file type; and
downloading said application if said user wants to do so.

2. The method according to claim 1, further comprising:
if said user has previously been asked about said file type, ignoring said file type.

3. The method according to claim 1, further comprising:
if said user does not want to download said application, remembering to ignore said file type in the future.

4. The method according to claim 1, further comprising:
forming a list of file types stored in the computer.

5. The method according to claim 4, wherein the step of forming the list of file types further comprises searching a file system on the computer.

6. The method according to claim 4, wherein the step of forming the list of file types further comprises reading meta data files on the computer.

7. The method according to claim 6, wherein the meta data files include at least one of the following:
bookmarks;
cache; and
history.

8. A method for deleting programs from a computer, the method comprising the computer-implemented steps of:
receiving a request from a user to delete a program from the computer;
determining if said program is the last program servicing a given file type on the computer; and
if said program is not the last program servicing said file type, deleting said program.

9. The method according to claim 8, further comprising:
if said program is the last program servicing said file type, searching the computer for files using said file type; and
if no files using said file type are found, deleting said program.

10. The method according to claim 9, further comprising:
if files using said file type are found, determining if said user wants to proceed with the deletion of said program;
if said user wants to proceed with the deletion of said program, deleting said program from the computer.

11. The method according to claim 8, further comprising:
determining if said user wants to delete said files using said file type; and
if said user wants to, deleting said files.

12. The method according to claim 11, further comprising:
determining if said user wants to delete said files one at a time;
if said user wants to delete said file one at a time, deleting all of said files at once; and
if said user does not want to delete all of said files, deleting individual files specified by said user.

13. A computer program product in a computer readable medium for use in a data processing system, for downloading applications to a computer for use with particular file types, the computer program product comprising:
first instructions for opening a browser program in response to a request from a user;
second instructions for determining if a given file type has an associated application on the computer;
if said file type does not have said associated application on the computer, third instructions for determining if said user has previously been asked about said file type;
if said user has not previously been asked about said file type, fourth instructions for asking if said user wants to download said associated application for said file type; and
fifth instructions for downloading said application if said user wants to do so.

14. The computer program product according to claim 13, further comprising:
if said user has previously been asked about said file type, sixth instructions for ignoring said file type.

15. The computer program product according to claim 13, further comprising:
if said user does not want to download said application, seventh instructions for remembering to ignore said file type in the future.

16. The computer program product according to claim 13, further comprising:
eighth instructions for forming a list of file types stored in the computer.

17. The computer program product according to claim 16, wherein the eighth instructions further comprise searching a file system on the computer.

18. The computer program product according to claim 16, wherein the eighth instructions further comprise reading meta data files on the computer.

19. The computer program product according to claim 18, wherein the meta data files include at least one of the following:
bookmarks;
cache; and
history.

20. A computer program product in a computer readable medium for use in a data processing system, for deleting programs from a computer, the computer program product comprising:
first instructions for receiving a request from a user to delete a program from the computer;
second instructions for determining if said program is the last program servicing a given file type on the computer; and
if said program is not the last program servicing said file type, third instructions for deleting said program.

21. The computer program product according to claim 20, further comprising:
if said program is the last program servicing said file type, fourth instructions for searching the computer for files using said file type; and
if no files using said file type are found, fifth instructions for deleting said program.

22. The computer program product according to claim 21, further comprising:
if files using said file type are found, sixth instructions for determining if said user wants to proceed with the deletion of said program;
if said user wants to proceed with the deletion of said program, seventh instructions for deleting said program from the computer.

23. The computer program product according to claim 20, further comprising:
eighth instructions for determining if said user wants to delete said files using said file type; and
if said user wants to, ninth instructions for deleting said files.

24. The computer program product according to claim 23, further comprising:
tenth instructions for determining if said user wants to delete said files one at a time;
if said user wants to delete said file one at a time, eleventh instructions for deleting all of said files at once; and
if said user does not want to delete all of said files, twelfth instructions for deleting individual files specified by said user.

25. A system for downloading applications to a computer for use with particular file types, the system comprising:
a calling component for opening a browser program in response to a request from a user;
a first look-up component for determining if a given file type has an associated application on the computer;
if said file type does not have said associated application on the computer, a second look-up component for determining if said user has previously been asked about said file type;
if said user has not previously been asked about said file type, a prompting component for asking if said user wants to download said associated application for said file type; and
a downloading component for downloading said application if said user wants to do so.

26. A system for deleting programs from a computer, the system comprising:
an input component for receiving a request from a user to delete a program from the computer;
a look-up component for determining if said program is the last program servicing a given file type on the computer; and
if said program is not the last program servicing said file type, a deletion component for deleting said program.
